(19) United States
(12) Patent Application Publication
(10) Pub. No.: US 2026/0118738 A1
(43) Pub. Date: Apr. 30, 2026

(54) IMAGING DEVICE AND METHOD

(71) Applicant: ODYSIGHT.AI LTD., Omer (IL)

(72) Inventors: Amir GOVRIN, Ramat Gan (IL); Hasan ABU EL RUB, Baqa El-Ghabiyye (IL)

(21) Appl. No.: 19/369,436

(22) Filed: Oct. 27, 2025

Related U.S. Application Data
(60) Provisional application No. 63/712,470, filed on Oct. 27, 2024.

(51) Int. Cl. G03B 15/03; G03B 13/36

(52) U.S. Cl. CPC G03B 15/03; G03B 13/36

(57) ABSTRACT

An imaging system includes an optical assembly and an illumination assembly enclosed by a housing. The optical assembly includes:
an image sensor, configured for capturing images of a region of interest;
an adjustable lens assembly, comprising at least one optical lens; and
a lens focusing mechanism coupled to said adjustable lens assembly, configured for
adjusting said lens to obtain at least one specified focal property for the image sensor.

The illumination assembly includes:
at least one lighting element, configured to illuminate the region of interest being imaged by the image sensor; and
an illumination focusing mechanism associated with said lens focusing mechanism, configured for adjusting an illumination parameter of said at least one lighting element in coordination with said lens focusing mechanism so as to obtain lighting conditions suitable for said image sensor.

The illumination focusing mechanism is controllable from outside the housing after the housing is sealed.

### CROSS REFERENCE TO RELATED APPLICATIONS

This application claims the benefit of priority of U.S. Provisional Patent Application No. 63/712,470, filed Oct. 27, 2024, the contents of which are incorporated herein by reference in their entirety.

### TECHNICAL FIELD

Embodiments of the present invention relate to imaging devices in general and in particular to imaging devices for harsh environments, such as for imaging industrial devices including aviation, maritime, transportation, energy and other devices. Imaging devices according to the invention may be used for example for the purpose of preventive maintenance or health monitoring of industrial machines.

### BACKGROUND

Machine maintenance is a critical part of the operation of any plant or facility that uses mechanical, electronic, or other systems and is required for lowering the risk of accidents and injuries, reducing maintenance costs, minimizing downtime of the system or components thereof, and meeting schedules.

Machine maintenance may include regularly scheduled service visits, routine checks, and schedules or emergency repairs. Part of the maintenance may include replacement, repair, or readjustment of parts that are worn, damaged, misaligned, expired, or the like, or are expected to be so before the next scheduled visit.

Predictive maintenance or health monitoring using optical sensors is known for example from WO2022/162663 the contents of which is incorporated herein by reference in their entirety and for all purposes. Optical sensors are fixed on or in vicinity of a machine or component thereof or where their field of view includes the machine or component, and the images are analysed for any anomalies.

The visual sensors are often positioned in harsh environments. For some industrial devices, such as in aviation, the visual sensors are required to pass quality tests for verification before being installed on the devices.

### SUMMARY

Objects of some embodiments according to the disclosure relate to imaging devices and systems that can be adjusted without opening a protective housing of the imaging system. Objects of some embodiments according to the disclosure may solve the problem of offering an adaptable solution for continuous and effective monitoring of industrial machinery in extreme environmental conditions.

An object of embodiments of the present invention relate to imaging devices where the lens focus of the imaging device can be adapted after sealing a housing of the device and/or after passing qualification (Qual) tests. According to some embodiments, the imaging devices are adapted to be installed in harsh environments.

An object of some embodiments according to the disclosure relates to a manual focus mechanism, permitting lens focus adjustments without the need to open the protective housing of the imaging system.

Devices installed in industrial environments are often required to pass qualification tests to ensure their reliability in extreme operating conditions. Examples of such extreme conditions may include one or more of: extreme temperatures for example, temperatures ranging from −45° C. to 70° C., high altitudes such as altitudes up to 45,000 ft, intense shocks, for example of 20g, varying humidity levels, immersion in liquid, and/or corrosive salty environments.

In order to ensure passing of these tests, imaging devices are often enclosed in protecting housings, the housing enclosing one or more of, an image sensor (also denoted herein a camera), a lens assembly, illumination sources (also denoted herein lighting elements), a processor and an energy source. Thus, often the lens assembly is enclosed in a (sealed) housing before being positioned in the industrial device. The inventors of the present application have found that adjusting focus of the lens assembly in such imaging devices may be problematic as the focus is best adjusted upon instalment in the industrial device, based upon settings in real time. Automatic focus mechanisms are not adapted to harsh environments as they usually require floating parts and/or magnetic elements which are not adapted for harsh environments. On the other hand, manually rotating the lens ring requires opening the protective housing which was sealed in order to pass the qualification tests.

An object of the present invention relates to imaging devices enclosed in a housing where the lens focus mechanism can be adjusted after closure of the housing. According to some embodiments, an extension is provided to the lens ring which can be adjusted by an adjustment mechanism accessible from the outer surface of the housing.

According to some embodiments, the ring surrounding the lens is provided in the form of a worm ring. The worm ring comprises an inner bore sized to engage the lens, and an outer circumference equipped with a series of radial teeth. In some embodiments, a worm shaft is further provided. The worm shaft comprises a helical thread that spirals around a portion of its outer surface. The helical thread is designed to engage with the corresponding teeth of the worm ring. Optionally, the shaft extends to an aperture or extension in the housing allowing for manipulation of the shaft when the housing is closed. Alternatively, an additional extension is provided between the shaft and the housing for manipulating the shaft. The housing may also be equipped with seals and/or gaskets to prevent ingress of moisture and/or contaminants and ensure the internal components remain clean and intact.

According to other embodiments, adjustment of the focus mechanism from the closed housing is provided by other means, such as gears, belt and pulley or other means.

Optionally, the housing extension is designed to transmit rotational input from an external source, such as a motor or manual tool, to the worm shaft or other adjustment means. Optionally, the shaft extension is supported by bearings mounted within the housing, providing smooth and stable rotation.

The shaft extension may feature a coupling interface for easy connection to a drive mechanism. This interface can include various coupling types, for example keyed shafts, splined connections or threaded interfaces.

Another object of some embodiments according to the disclosure relates to adjusting illumination sources after closing a housing in which the imaging device and illumination source(s) are positioned. According to some embodiments, the housing encloses an image sensor, a lens assembly and a plurality of illumination sources. According to some embodiments, at least two of the illumination sources are covered with lenses having different focus, different fields of view, different diffusers or the like. For example, the lenses may differ in focal length, refraction, aperture control, beam angle, lens shape, lens type, diffusion and/or distance from light source. Alternatively or additionally, in some embodiments at least two of the illumination sources differ in intensity, strobe frequency and/or pulse duration. In some embodiments, control of which light source to activate for imaging is provided after housing and positioning of the imaging device according to the required illumination on site. Optionally, the different illumination sources provide for illumination by the imaging devices at different ranges from the region of interest. Optionally, the different illumination sources provide for creating a shadow of a region of interest and imaging the shadow for analysis of the region of interest.

Another object of the present invention relates to coordinating the focus of the imaging sensor and the focus of lighting element(s) illuminating the region of interest being imaged by the imaging sensor.

In some embodiments of the disclosure, an imaging system includes mechanisms that enable adjustment of the camera focus and/or the illumination beam focus in a coordinated manner, so that suitable illumination conditions are achieved at the region of interest being imaged by the camera. A focusing mechanism of the image sensor lens adjusts one or more optical parameters of the camera, including but not limited to one or more of the focus distance, focal length, depth of field and field of view (FOV). Adjustment of these parameters changes the distance at which an object appears sharply on the image sensor and may influence image magnification and image sharpness. In some embodiments of the disclosure, these adjustments are achieved by altering the position or spacing of one or more optical elements within the lens assembly.

The illumination focus mechanism, in turn, modifies optical characteristics of the emitted light such as beam divergence, focal distance, collimation, and illumination spot size on the target region. Adjustment of these illumination parameters may be achieved by moving a lens element relative to a light source, shifting the light source relative to a reflector, or inserting a diffuser into or out of the beam path. These changes allow the illumination to be optimized for different imaging distances and/or for varying sizes of the region of interest.

As used herein, according to some embodiments of the disclosure, the term “in coordination with”, “coordinated adjustment”, and similar terms refer to operation, control, or adjustment of one, two or more components in a manner such that their respective functions are correlated to achieve a common operational effect, such as providing suitable (or even optimal) lighting for the image sensor. The coordination may be implemented in various ways, possibly including but not limited to: (i) mechanical coupling through a common mechanism; (ii) electrical or electronic control through a shared control signal; or (iii) separate control signals or mechanisms that operate in a manner producing correlated or interdependent adjustment of the respective components.

As used herein, the term “suitable lighting conditions” and similar terms are to be broadly construed as being lighting conditions in which the image sensor is capable of capturing an image of the region of interest of acceptable quality for further processing steps that may be performed on it.

According to a first aspect of some embodiments of the present disclosure there is provided an imaging system comprising an optical assembly and an illumination assembly.

The optical assembly comprises:
an image sensor, configured for capturing images of a region of interest;
an adjustable lens assembly associated with the image sensor, and including at least one optical lens; and
a lens focusing mechanism coupled to the adjustable lens assembly, configured for adjusting the lens to obtain at least one specified focal property for the image sensor; and
   The illumination assembly is enclosed by a housing and includes:
at least one lighting element, configured to illuminate the region of interest being imaged by the image sensor; and
an illumination focusing mechanism associated with the lens focusing mechanism, configured for adjusting an illumination parameter of the at least one lighting element in coordination with the lens focusing mechanism so as to obtain lighting conditions suitable for the image sensor,
   wherein the illumination focusing mechanism is controllable from outside the housing after the housing is sealed.

According to some embodiments of the first aspect of the present disclosure, the housing further encloses the optical assembly, and the lens focusing mechanism is controllable from outside the housing after the housing is sealed.

According to some embodiments of the first aspect of the present disclosure, the illumination parameters include at least one parameter selected from the group consisting of: a divergence of a light beam emitted by the lighting element, a focus of the light beam emitted by the lighting element, a collimation of the light beam emitted by the lighting element and a dispersion of the light beam emitted by the lighting element.

According to some embodiments of the first aspect of the present disclosure, the illumination assembly comprises a plurality of independently adjustable lighting elements.

According to some embodiments of the first aspect of the present disclosure, the adjusting an illumination parameter comprises selecting at least one of plurality of lighting elements for operation.

According to some embodiments of the first aspect of the present disclosure, at least two of the lighting elements have different wavelengths.

According to some embodiments of the first aspect of the present disclosure, the lens focusing mechanism and the illumination focusing mechanism are mechanically coupled, such that adjusting the lens focusing mechanism mechanically adjusts the illumination focusing mechanism.

According to some embodiments of the first aspect of the present disclosure, the lens focusing mechanism and the illumination focusing mechanism are controlled in coordination by a processing circuitry transmitting instructions to one or more drivers.

According to some embodiments of the first aspect of the present disclosure, the lens focusing mechanism and the illumination focusing mechanism are adjusted from outside the housing by respective actuators.

According to some embodiments of the first aspect of the present disclosure, the illumination focusing mechanism comprises a lens that is movable forwards and backwards along the optical axis of a light beam emitted by the at least one lighting element.

According to some embodiments of the first aspect of the present disclosure, the illumination focusing mechanism comprises a reflector, and the at least one lighting element is movable closer and farther from a focal point of the reflector.

According to some embodiments of the first aspect of the present disclosure, the illumination focusing mechanism comprises a reflector that is insertable and removable from a light beam emitted by the at least one lighting element.

According to some embodiments of the first aspect of the present disclosure, the focal properties of the image sensor include at least one of a group consisting of: focal distance, focal length, depth of field and field of view.

According to some embodiments of the first aspect of the present disclosure, the illumination system further includes a processing circuitry configured for:
receiving the at least one specified focal property for the image sensor;
determining the illumination parameters that create the suitable lighting conditions based on the specified focal properties; and
controlling the lens focusing mechanism to provide the specified focal properties and controlling the illumination focusing mechanism to provide the determined illumination parameters.

According to some embodiments of the first aspect of the present disclosure, the illumination assembly includes multiple independently adjustable lighting elements and at least one of the lighting elements is adjustable separately from the image sensor lens.

According to a second aspect of some embodiments of the present disclosure there is provided method for imaging a mechanical component. The method includes:
installing an imaging system comprising an optical assembly and an illumination assembly. The optical assembly includes: an image sensor comprising an adjustable lens assembly, and configured for capturing images of a region of interest, and a lens focusing mechanism coupled to the adjustable lens, configured for adjusting the lens assembly to obtain at least one specified focal property for the image sensor. The illumination assembly includes: at least one lighting element, configured to illuminate the region of interest being imaged by the image sensor, and an illumination focusing mechanism associated with the lens focusing element, configured for adjusting an illumination parameter of the at least one lighting element.
adjusting the lens assembly using the lens focusing mechanism to obtain the at least one specified focal property in coordination with adjusting the at least one lighting element using the illumination focusing mechanism, so as to obtain lighting conditions suitable for image capture of the region of interest by the image sensor; and
capturing at least one image of the region of interest by the image sensor.

According to some embodiments of the second aspect of the present disclosure, the illumination assembly is enclosed by a housing and is controllable from outside the housing after the housing is sealed.

According to some embodiments of the second aspect of the present disclosure, adjusting the at least one lighting element includes varying at least one parameter selected from the group consisting of: a divergence of the light beam emitted by the lighting element, a focus of the light beam emitted by the lighting element, a collimation of the light beam emitted by the lighting element, and a dispersion of the light beam emitted by the lighting element.

According to some embodiments of the second aspect of the present disclosure, illuminating the region of interest includes controlling a plurality of independently adjustable lighting elements, wherein adjusting the illumination parameter comprises selecting at least one of the plurality of lighting elements for operation.

According to some embodiments of the second aspect of the present disclosure, the focal properties of the image sensor include at least one of a group consisting of: focal distance, focal length, depth of field and field of view.

According to some embodiments of the second aspect of the present disclosure, the method further includes:
analyzing the at least one captured image to determine if current lighting conditions are suitable for image capture of the region of interest by the image sensor;
if current lighting conditions are unsuitable, updating at least one setting of the lens focusing mechanism and/or the illumination focusing mechanism; and
applying the at least one updated setting to the lens focusing mechanism and/or the illumination focusing mechanism.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system or method. For example, some embodiments of the present disclosure may take the form of an entirely hardware embodiment or an embodiment combining software and hardware aspects that may all generally be referred to herein as a “circuitry,” “module”, “assembly” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g. using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example, illustrating exemplary methods and/or apparatus (systems) and/or computer program products according to embodiments of the present disclosure. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments according to the disclosure, unless otherwise indicated. In the drawings like reference numerals are used to indicate corresponding parts.

In block diagrams and flowcharts, optional elements/components and optional stages may be included within dashed boxes.

In the figures:

FIG. 1 is a simplified block diagram of an imaging device according to some embodiments of the disclosure;

FIGS. 2A-2F illustrating an imaging system 200 according to some embodiments of the disclosure including elements similar to imaging system 100. FIG. 2A is a schematic illustration of an exemplary imaging device 200 according to some embodiments of the disclosure. FIG. 2B is a schematic illustration of focus parts of imaging system 200. FIG. 2C is a side view of imaging system 200 and FIG. 2D is a cross-sectional view of imaging system 200 according to line C in FIG. 2C. FIG. 2E is an enlarged view of area D in FIG. 2D and FIG. 2F is an exploded view of imaging system 200 according to some embodiments of the disclosure;

FIG. 3 shows simplified block diagrams of illumination source(s) used according to some embodiments of the disclosure;

FIG. 4 is a simplified flowchart of a method of setting an imaging device at a scene for example for predictive maintenance purposes;

FIGS. 5A-5B are simplified block diagrams of an imaging system, according to respective embodiments of the present disclosure;

FIGS. 6A-6C are simplified illustrations of illumination focus adjustment techniques, according to respective exemplary embodiments of the disclosure;

FIGS. 7A-7B are simplified illustrations of coupled illumination focus adjustment mechanisms, according to respective exemplary embodiments of the disclosure; and

FIG. 8 is a simplified block diagram of an imaging system with processor control, according to an exemplary embodiment of the disclosure;

FIG. 9 is a simplified flowchart of a method for imaging a mechanical component, according to some embodiments of the disclosure.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

The present disclosure, in some embodiments, thereof, relates to imaging devices in general and in particular to imaging devices for harsh environments, such as for imaging industrial devices including aviation, maritime, transportation, energy and other devices. Imaging devices according to the invention may be used for example for visual sensing for machine maintenance. Imaging devices may produce still images, video sequences or combinations thereof.

One technical problem of embodiments of the present invention relates to the need to seal imaging devices before their positioning in a location from which the region of interest may be captured, and before final definition of focus requirement. For example, when installing imaging devices in industrial devices operating in harsh environments, the imaging devices need to undergo qualification testing before their instalment in the industrial device. The imaging devices are often enclosed by sealed housings including their lens assembly and sometimes also their illumination sources. Upon instalment there is often a need to adjust the focus of the lens assembly according to the actual position of the imaging device and region of interest imaged. Autofocus adjustment are often not well suited for harsh environment. Thus, there is a need for manual adjustment of lens focus without opening a (sealed) housing in which the imaging device is positioned.

Another technical problem of embodiments of the present invention relates to adapting illumination of imaging devices after closing their housing. In cases for example such as monitoring industrial devices, the imaging device is often positioned in harsh environments where proper illumination is crucial, for example requiring highlighting of specific region of interests in the field of view and reducing harsh shadows. The imaging device is often small and positioned close to the region of interest and requires exact concentration of light.

Thus, there is a need of dynamic adjustment focus of illumination without opening a (sealed) housing in which the imaging device is positioned.

Another technical problem relates to coordinating the focus of an image sensor with the focus of lighting element(s) providing illumination for the image sensor. The image sensor is positioned to image a particular region of interest, and it is important that the lighting conditions in that region are suitable for obtaining a high-quality image. If the image sensor's focus is changed, it is desirable that the lighting conditions be changed accordingly in order to illuminate the new region focused on by the image sensor.

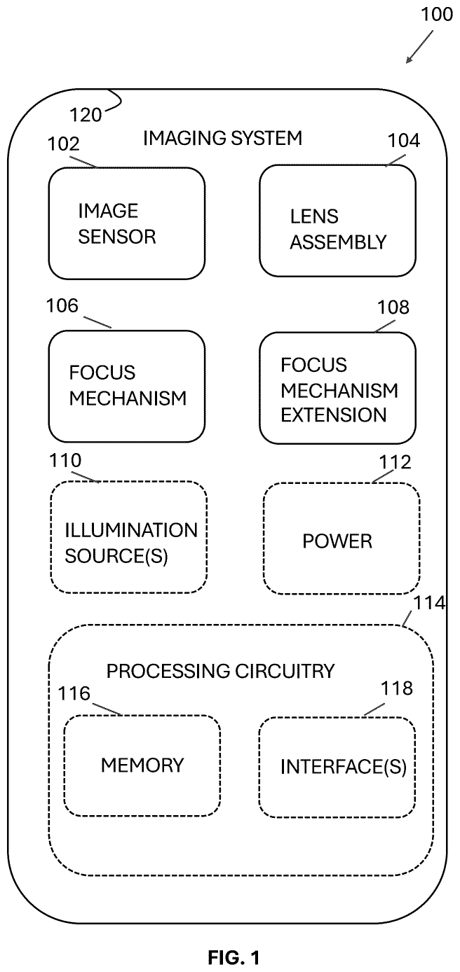

Reference is now made to FIG. 1, which is a simplified illustration of an exemplary imaging system 100 according to some embodiments of the disclosure.

Imaging system 100 according to some embodiments of the disclosure comprises an image sensor 102, a lens assembly 104, a lens focus mechanism 106 and a focus mechanism extension 108 which is accessible from a protective housing 120 of the imaging system.

Protective housing 120 is optionally designed to maintain the sustainability of the system in harsh conditions. Optionally, housing 120 is made from a material constructed to withstand extreme temperatures and corrosive substances, such as aluminium. Optionally, the housing is coated by a coating that is anodic to the housing material to enhance its resistance to corrosion for example. In some embodiments, protective housing 120 may be submerged in liquid (such as water or oil), and thus needs to be made of a material that can withstand the conditions.

In some embodiments, the thickness of the housing is also constructed to adapt to harsh conditions, for example the housing material may have a thickness of 2 mm or less, such as 1 mm or even 0.7, 0.6 or 0.5 mm for certain environments.

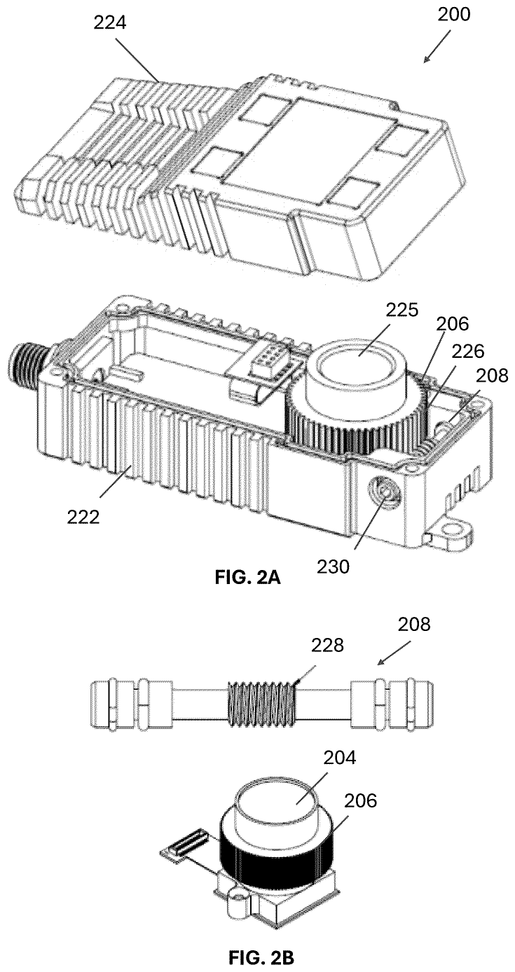

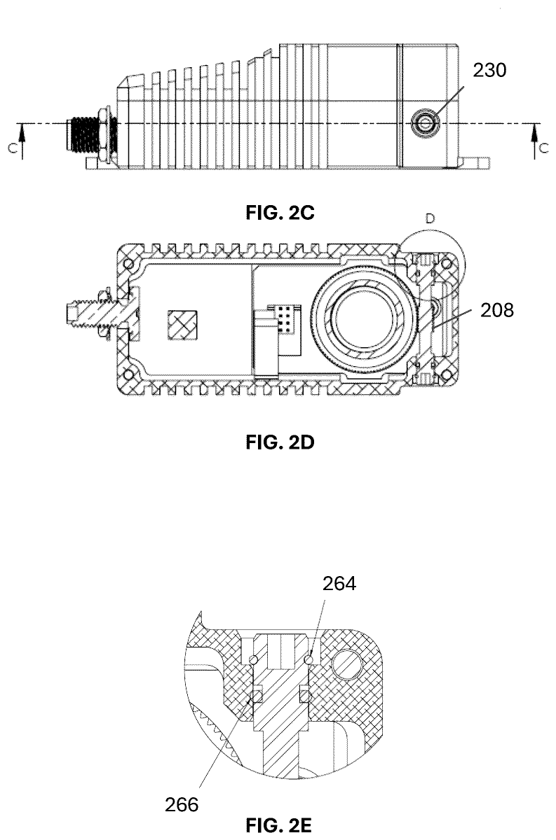

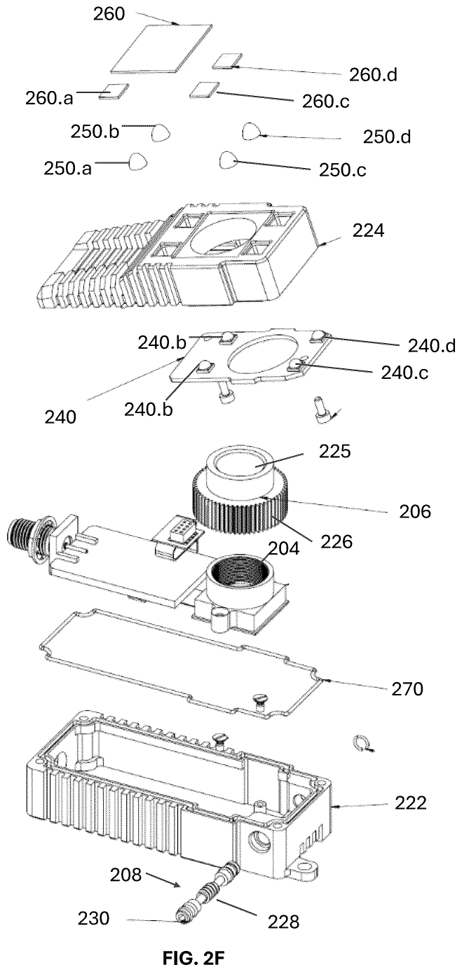

Focus mechanism extension 108 extends from lens focus mechanism 106 and extends to a manipulatable member accessible from the external surface of housing 120. Focus mechanism extension 108 allows for the adjustment of lens assembly 104 without the need to open housing 120 as further elaborated with respect to FIG. 2 below.

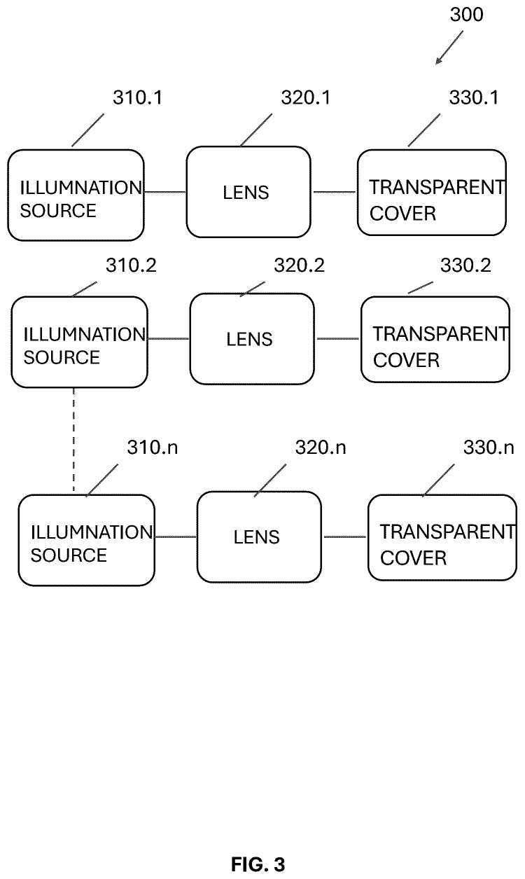

Imaging device 100 optionally further includes one or more illumination sources 110 as further detailed with respect to FIG. 3 below. Alternatively, external illumination is used. A power source 112 (such as a battery) may also be provided within imaging devices 100. Alternatively, imaging device 100 may be connected to an external power source.

A processing circuitry 114 including one or more processors may be provided for controlling operation of imaging device 100. Optionally, memory 116 is also provided for storing processing instructions and/or captured image data. Processing circuitry 114 may process the image data provided by the imaging system and may also perform other tasks, such as providing a graphical user interface (GUI) to a user and processing inputs from the GUI and/or other input/output means.

Processing circuitry 114 according to some embodiments of the disclosure may be an Application Processor, a Central Processing Unit (CPU), a Graphics Processing Unit (GPU), Application Specific Integrated Circuit (ASIC), a microprocessor, an Integrated Circuit (IC) or the like. Alternatively, processing circuitry 114 can be implemented as firmware written for or ported to a specific processor such as digital signal processor (DSP) or microcontrollers, or can be implemented as hardware or configurable hardware such as field programmable gate array (FPGA).

One or more interfaces 118 may also be provided for inputting and/or outputting data. For example, the interface(s) may serve to output image data and/or communicate with other components in a machine and/or to communicate with external machines or systems, and/or to provide focus changing instructions, and/or to provide a user interface.

Referring now to FIGS. 2A-2F illustrating an imaging system 200 according to some embodiments of the disclosure including elements similar to imaging system 100. FIG. 2A is a schematic illustration of an exemplary imaging device 200 according to some embodiments of the disclosure. FIG. 2B is a schematic illustration of focus parts of imaging system 200. FIG. 2C is a side view of imaging system 200 and FIG. 2D is a cross sectional view of imaging system 200 according to line C in FIG. 2C. FIG. 2E is an enlarged view of area D in FIG. 2D and FIG. 2F is an exploded view of imaging system 200 according to some embodiments of the disclosure.

The protective housing shown is formed of two parts, a bottom part 222 and an upper part 224 for manufacturing which are joined together before set-up, installation and/or testing of the imaging system. Optionally, the two parts are joined together using screws or alternatively glued together. Optionally, seals such as o-rings, gaskets or a sealant, are used to prevent ingress of moisture and/or contaminants and ensure the internal components remain clean and intact. Optionally, a seal is provided along the engagement portion between parts 222 and 224. For example, FIG. 2F illustrates such a seal 270 which may be formed of rubber, EPDM or similar sealing materials.

Imaging system 200 according to some embodiments includes a lens assembly 204 including one or more lenses, a focus mechanism 206 and a focus mechanism extension 208.

Lens assembly 204 can be chosen according to the imaging requirements of the imaged field. For example, depending on the distance of the camera from the imaged object, the sensitivity requirements and the field of view (FOV) required. For example, the lens assembly may have a focal length adapted to capture a FOV of 30°, 50°, 70°, 90° or 120°.

Focus mechanism 206 is provided to adjust focus of the lens assembly. According to some embodiments of the disclosure, focus is adjusted before closure of the housing using focus mechanism 206 according to an expected desired focus. Focus mechanism 206 is illustrated in the form of a worm ring and comprises an inner bore 225 sized to engage the one or more lenses, and an outer circumference equipped with a series of radial teeth 226.

In some embodiments, focus is further adjusted after sealing of the housing, for example when the imaging system is installed in or around the machine to be monitored and additional adjustment are required to the lens focus. A focus mechanism extension is thus provided to enable focus from outside the housing without requiring opening of the housing and seal. In the illustrated embodiment, a worm shaft 208 is provided, optionally comprising a helical thread 228 that spirals around a portion of its outer surface. The helical thread is designed to engage with the corresponding teeth of radial teeth 226 of worm ring 206. Worm shaft 208 further extends to a manipulatable member 230 accessible from the external housing allowing for manipulation of the shaft when the housing is closed.

According to some embodiments, manipulatable member 230 is an end of shaft 208 which fits through an aperture in the housing as illustrated in FIG. 2F. Such embodiments require sealing of the aperture to prevent ingress of moisture and/or contaminants and ensure the internal components remain clean and intact. Exemplary sealing according to embodiments of the disclosure is illustrated for example in FIG. 2D which is a cross section along line C shown in FIG. 2C along extension 230 and the enlarged portion D in FIG. 2E. As shown, a snap ring 264 and/or an o-ring 266 are provided at the engagement of shaft 208 with the external housing to enable smooth rotation and prevent ingress of moisture and contaminants into the housing. Optionally, o-ring 266 is made from rubber, EPDM or similar materials enabling rotating while keeping the housing sealed.

According to other embodiments (not shown), manipulatable member 230 is part of the housing engaging the end of shaft 208 thereby facilitating sealing of the housing.

According to some embodiments, a tool (not shown) is provided adapted to engage manipulatable member 230 and transmit rotational input thereby rotating focus mechanism 206. The tool may be manually operated, which is particularly applicable for example in embodiments where the focus is adjusted before sealing of the housing and only small adjustments are expect to the focus post-sealing. Alternatively, a motor is provided to the tool to transmit force from an external source. Optionally, shaft extension 208 is supported by bearings mounted within the housing, providing smooth and stable rotation.

In another embodiment (not shown), focus mechanism extension extends from focus mechanism 206 upwards to a manipulatable member in upper surface 224 of the housing. Such extension may operate similar to extension 208 shown or differ for example by using gears instead of a worm shaft.

The exploded view in FIG. 2F further illustrates illumination sources according to some embodiments of the disclosure. According to some embodiments, as shown four illumination sources 240a-d provided on a board 240 according to some embodiments of the disclosure. It is submitted that the illustration of four illumination sources is exemplary only and the invention covers any other number of illumination sources used such as 2, 6, 8, 10, 12 or any other number of illumination sources.

The illumination sources according to embodiments of the disclosure can be positioned surrounding lens assembly 204 as shown in FIG. 2. According to some embodiments, the illumination sources are positioned evenly surrounding the lens assembly, for example, in an embodiment comprising 2 illumination sources, the illumination sources are optionally positioned above and below (or right and left of) the lens assembly such that a line between the illumination sources would cross the lens assembly in half. Optionally, the illumination sources can be positioned in a concentric circle around the lens assembly. In other embodiments, the illumination sources can focus on one side of the lens assembly thereby focusing the illumination from one side of the lens assembly. Such embodiments could optionally create a shadow of a region of interest which may enlarge the region of interest and ease its visual analysis for faults.

In addition, any type of illumination can be used according to embodiments of the disclosure, such as a light emitting diode (LED), light bulb, laser, electroluminescent wire, and light transmitted via fiber optic wires or cables (e.g. from a LED coupled to the fiber optic cable).

Objects of embodiments according to the disclosure relates to an imaging device comprising a plurality of illumination sources, wherein at least two of the illumination sources comprise different parameters, to enable operating the illumination sources according to the requirements at the imaging scene.

According to some embodiments, imaging system 100 comprises two or more illumination sources, as shown in FIG. 2F for example illustrating four illumination sources 204a-d. Illumination sources 240a-d can be of a same type, possibly having different parameters, such as having different light wavelengths, different power, different diffusers, being covered by lenses with different properties, i.e. focal length and/or comprising different polarization.

According to some embodiments, each illumination source 240a-d has a covering lens 250a-d respectively, wherein at least two of the lenses 250a-d have different parameters such as different focus and/or field of view.

According to some embodiments, lenses 250a-d are further covered by a transparent window in the housing, i.e. glass covers 260a-d respectively (note that 260.b is not visible in FIG. 2F as it is hidden behind lens cover 260). Transparent covers 260a-d serve for protection of the internal components while still allowing maximum light transmission to the sensor. In addition, in some embodiments, covers 260a-d are coated to also serve as a filter, such as UV, IR cut-off or polarizing filter. Optionally, at least one of lenses 260a-d is covered by an anti-reflective hydrophobic coating. Optionally, at least one of lenses 260a-d is covered by a hydrophobic coating to prevent moisture buildup on the cover surface. According to some embodiments, at least two and possible all of glass covers 260a-d comprise different coatings. For example, at least two of covers 260a-d may comprise a different polarizer. Optionally, covers 260a-d are made of Sapphire glass to increase durability of the imaging device in harsh environments.

Providing different parameters to lenses and/or covers of a plurality of illumination sources potentially enables adaptation of illumination focus at the imaging scene when the imaging device is installed without requiring opening of the (sealed) housing. According to some embodiments, a processing circuitry controlling operation of the imaging device, such as circuitry 114, controls operation of the illumination sources according to the scene requirements. For example, if it is determined at the scene that the illumination should have a specified wavelength(s), focus and/or FOV, the illumination source having the respective lens may be operated and/or adjusted, while others having different lenses and/or filters will not be operated or operated at less power. In other embodiments, choosing the illumination sources adapted to the scene may be performed manually, i.e. upon installation of the imaging device or optionally automatically using trained modules.

Referring to FIG. 3 which is a simplified illustration of illumination source(s) with different parameters used according to some embodiments of the disclosure. An imaging system 300 includes two or more illumination sources 310.n (where n is to be understood as one, two or even more than two) which are optionally of different type, power, etc. Each illumination source is covered by a lens 320.n respectively, where different lenses may comprise different parameters as discussed with respect to FIG. 2F. In addition, according to some embodiments, a transparent cover 330.n is provided for each lens 320.n respectively. Transparent covers 320.n may comprise different parameters as well. In these embodiments, light distributed by illumination sources 310.n may differ in power, focus and filter. In some embodiments, the light sources are identical, and the difference is provided by the lens and/or transparent cover only.

In other embodiments, the light sources differ in type and/or intensity. Optionally, at least two of the light sources are operated at different pulse durations or strobe frequencies.

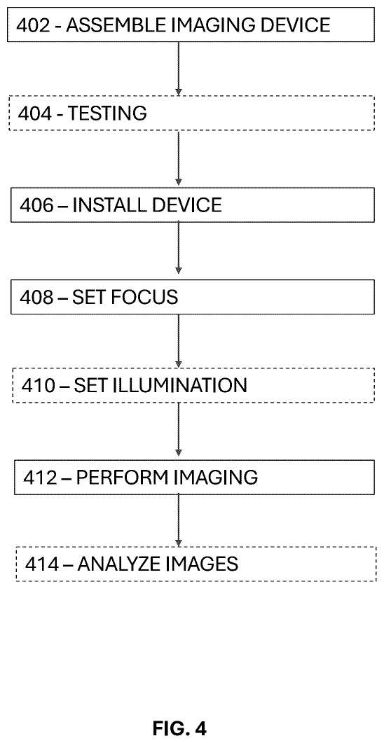

FIG. 4 illustrates a method of setting an imaging device at a scene for example for predictive maintenance purposes according to some embodiments of the disclosure. At 402 an imaging device is manufactured and sealed. The imaging device may be any of imaging device 100, 200 or 300 described above or any combination thereof. At 404, the imaging device optionally undergoes qualification testing. The testing is optional and performed when necessary and according to the field requirements, such as aviation for example.

At 406 the imaging device is positioned to image the scene. For example, the imaging device may be installed inside an industrial machine or a vehicle wherein at least a portion of a machine component is imaged. For example, cables of an elevator, a screw, bearing, crank shaft or other components of industrial devices such as transportation vehicles, trains and aviation airplanes, helicopters, UAV etc. The imaging device may be installed in harsh environments such as in extreme temperatures, high altitudes, and in the presence of shock, humidity, and salinity, in liquid or the like, for imaging (critical) machine components during operation of the machine. In some embodiments, the imaging device may be installed in hard-to-reach locations for imaging (critical) machine components without requiring dismantling of machine components.

At 408 focus of the imaging device is optionally refined without opening a sealed housing of the imaging device. Focus adjustment may be performed by using a manipulatable member accessible from the external surface of the housing according to any of the options described above. At 410 illumination of the imaging device is optionally set. According to some embodiments, illumination is set by controlling a plurality of illumination sources provided in the imaging device, for example as described above.

In some embodiments, illumination sources may be selected and set including the parameters discussed herein, strobe frequency and/or pulse duration is also set at 410. Optionally, the strobe frequency and/or pulse duration differs for different illumination sources. Additionally or alternatively, external illumination sources may be used.

At 412 imaging is performed using the imaging device. Imaging may be performed according to the maintenance requirements of the imaged scene, for example timing of the imaging device may be performed from continuously to once a predefined period. At 414 the images are analyzed for determining the health of the imaged scene and optionally maintenance is instructed accordingly.

### Coordinated Adjustment of Image Sensor Focus and Illumination Focus

Some embodiments according to the disclosure, are of an imaging system that includes an optical assembly and an illumination assembly. The optical assembly includes an image sensor and an adjustable lens assembly that adjusts the image sensor focus. The illumination assembly includes one or more lighting elements whose illumination properties (such as beam collimation, dispersion, focus etc. . . . ) may be controlled. The image sensor focus and the lighting element illumination parameters are adjusted in a coordinated manner, to provide optimal lighting conditions for the region of interest being imaged.

As used herein, the term “illumination parameters” refers to one or more controllable characteristics of a lighting element or illumination assembly that determine the properties of light provided to an area of interest. Such parameters may include, without limitation, an intensity or brightness of emitted light, a divergence or beam angle, a focus or convergence of the emitted light, a direction or orientation of illumination, a spatial uniformity of illumination across the field of view, a diffusion of the light beam, a spectral composition or wavelength distribution of the emitted light, a polarization state, and/or a temporal characteristic such as duration, pulsing, or synchronization with image capture. Adjustment of one or more illumination parameters may be performed to obtain lighting conditions suitable for image capture by an image sensor.

As used herein, the terms “image sensor focus” and “focal properties” refers to one or more characteristics of the optical assembly that determine the formation of an image on the image sensor. Such focal properties may include, without limitation, a focal distance, a focal length, a focus position, a depth of field, a field of view, or any other parameter influencing the convergence of light rays onto the image sensor. Adjustment of the focal properties may be performed, for example, by varying the position, curvature, or optical power of one or more lens elements within an adjustable lens or lens assembly.

In some embodiments, the imaging device includes one or more mechanisms that enable coordinated adjustment of one or both the image sensor focus and the illumination beam focus. The lens focusing mechanism adjusts one or more optical parameters of the camera, including the focus distance, focal length, and field of view (FOV). Adjustment of these parameters changes the distance at which an object appears sharply on the image sensor and may influence image magnification, depth of field, and image sharpness. Such adjustments are achieved by altering the position or spacing of one or more optical elements within the lens assembly.

The illumination focus mechanism, in turn, modifies optical characteristics of the emitted light such as beam divergence, focal distance, collimation, a diffuser location, and illumination spot size on the target region. Adjustment of these illumination parameters may be achieved by moving a lens element relative to a light source, shifting the light source relative to a reflector, or inserting a diffuser into or out of the beam path. These changes allow the illumination to be optimized for different imaging distances or for varying sizes of the region of interest.

In certain embodiments, the illumination focus mechanism is mechanically or electronically coupled to the camera's focusing mechanism so that a single actuation adjusts both the camera focus and the illumination beam simultaneously. For example, a gear train or worm drive may transmit motion from the camera focus control to one or more illumination focusing assemblies, optionally with different transmission ratios to tailor each illumination beam's focus profile. In other embodiments, the two focusing systems are controlled independently but in a coordinated manner, such as by software and/or actuator(s), to achieve customized lighting conditions for each imaging scenario.

Coordinating camera focus and illumination focus ensures that the region of interest is captured both optically sharp and optimally illuminated as the imaging distance or operating conditions change. This synchronization improves image quality, enhances contrast, and facilitates reliable detection of early-stage faults or wear in machine components during preventive maintenance operations.

In some embodiments of the disclosure, the focusing mechanism may be mechanically or electronically coupled to one or more illumination focus mechanisms such that adjustments to camera focus parameters are accompanied by corresponding adjustments to illumination beam focus, divergence, or intensity. This coordination ensures that the region of interest remains optimally illuminated and in sharp focus during imaging.

### Imaging System

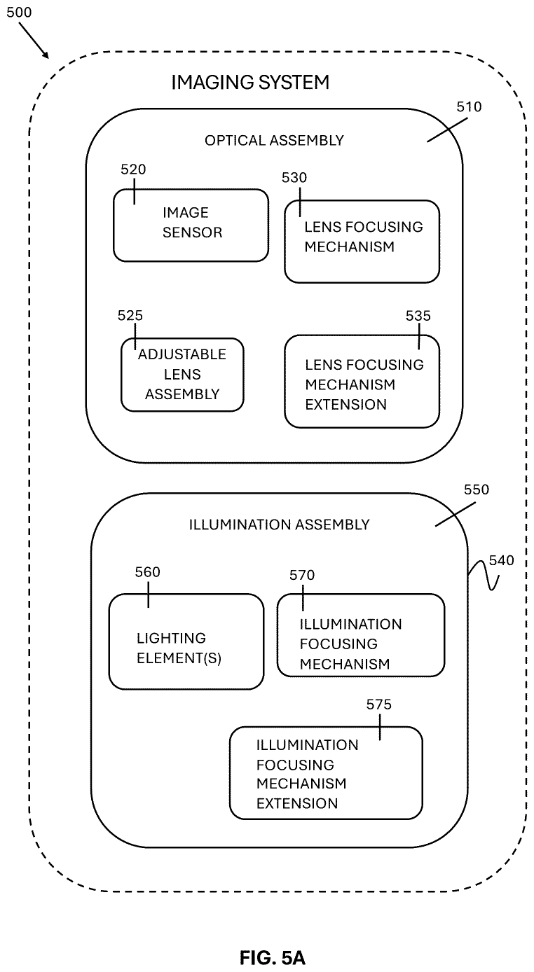

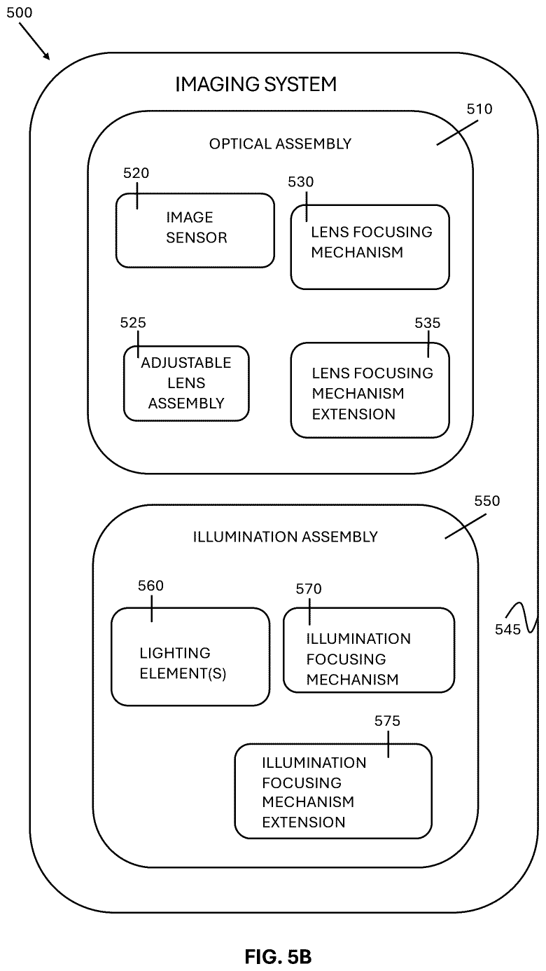

Reference is now made to FIGS. 5A-5B, which are simplified block diagrams of an imaging system, according to respective embodiments of the present disclosure.

Imaging system 500 includes an optical assembly 510 and an illumination assembly 550. According to some embodiments of the disclosure, optical assembly 510 and illumination assembly 550 are physically separate units and may be installed in different locations. According to alternate embodiments of the disclosure, optical assembly 510 and illumination assembly 550 are a single unit and installed at one location. In either case, lighting elements 560 are arranged to illuminate the area or areas of interest, which may be imaged by image sensor 520.

As will be apparent to the skilled person, some components of imaging system 500 may be implemented similarly to corresponding components described above. For example, in some embodiments of the disclosure lens focusing mechanism 530 may be implemented similarly to focus mechanism 106 of FIG. 1. The details of possible similar implementations of imaging system components are considered to be encompassed by the instant disclosure and are not repeated here.

### Optical Assembly

Optical assembly 510 includes an image sensor 520 coupled with an adjustable lens assembly 525. Adjustable lens assembly 525 may include one or more optical lenses. Adjustable lens assembly 525 is coupled to a lens focusing mechanism 530 and is configured for adjusting the focus of the lens assembly to obtain at least one specified focal property for the image sensor 520.

In a first example, the at least one specified focal property is a specified focal distance.

In a second example, the at least one specified focal property is a specified focal length.

In a third example, the at least one specified focal property is a specified field of view.

In a fourth example, the focal property is a specified depth of field.

In a fifth example, the at least one specified focal property is any combination of two or more of: focal distance, focal length, field of view and depth of field.

Lens focusing mechanism 530 modifies the optical path between the object and the image sensor. Such adjustment may alter the focus distance, that is the object location at which the image is sharply formed on the sensor. It may also vary the effective focal length of the lens system, thereby influencing magnification and the field of view (FOV) captured by the camera. In addition, changes in focus affect the depth of field (DOF), defining the range of distances that appear acceptably sharp in the image. Proper focusing maximizes image sharpness and resolution by aligning the optical focal plane with the sensor plane.

In some embodiments of the invention, lens focusing mechanism 530 physically moves one or more lenses in lens assembly 525, thereby changing the distance between the lens or lenses and the image sensor. This movement results in changes to the focal properties of the image sensor.

According to some embodiments of the disclosure, lens focusing mechanism 530 is located within a housing, and optical assembly 510 further includes a lens focusing mechanism extension 535. Lens focusing mechanism extension 535 is mechanically or electronically linked to lens focusing mechanism 530 and extending to or through the housing. Lens focusing mechanism extension 535 allows manual or motorized actuation of lens focusing mechanism 535 from outside the housing after the housing is sealed.

### Illumination Assembly

The illumination assembly 550 comprises one or more lighting elements 560, such as LEDs, lasers, or other light sources. Lighting elements 560 need to be configured to illuminate the region of interest to be imaged by the image sensor 520. The illumination assembly 550 further includes an illumination focusing mechanism 570 operatively coupled with the lens focusing mechanism 530.

Adjustment of the illumination focus mechanism 570 modifies one or more optical properties of the illumination beam emitted from the illumination source and/or changes in properties of the illumination beam between the lighting element and the region of interest. Such adjustment may include varying the beam divergence angle, focal distance, collimation, or illumination spot size at a target region. For example, the illumination focus mechanism may move a lens element relative to the light source, shift the light source relative to a reflector, or insert a diffuser into or out of the beam path. These adjustments allow the illumination to transition between a narrow, collimated beam suitable for distant targets and a wide, diffuse beam suitable for close-range imaging.

In some embodiments, illumination focusing mechanism 570 is configured to adjust one or more illumination parameters of the lighting element 560 so as to obtain lighting conditions suitable for the optical properties set by the lens focusing mechanism 530.

In some embodiments of the invention, adjusting one or more illumination parameters includes one or more of:
1. Adjusting the divergence of a beam of a lighting element;
2. Adjusting the collimation or dispersion of a light beam emitted by a lighting element;
3. Selecting one or more lighting elements for operation;
4. Adjusting the beam direction of a lighting element;
5. Adjusting the focus of a lighting element; and
6. Adjusting the coverage area of the lighting element.

The mechanical structure of illumination focusing mechanism 570, and its interconnection with other components of imaging system 500, depends on the manner in which the illumination parameters are controlled. In an example illumination focusing mechanism 570 is a worm screw and gear train, similar to the design of the lens focusing mechanism. This is only one option; many other mechanisms, with or without transmission ratios, are also possible.

Optionally, the lens focusing mechanism 530 and the illumination focusing mechanism 570 are mechanically coupled, such that actuation of the lens focusing mechanism 530 causes a corresponding adjustment in the illumination focusing mechanism 570, ensuring that the focal distance and lighting pattern remain synchronized or harmonized relative to the region of interest. In other embodiments, the two mechanisms are controlled electronically in coordination, for example by a processor that issues control signals to respective drivers or actuators.

According to some embodiments of the disclosure, illumination focusing mechanism 570 is located within housing 540 and illumination assembly 550 further includes an illumination focusing mechanism extension 575 mechanically linked to illumination focusing mechanism 570 and extending to or through housing 540. Illumination focusing mechanism extension 575 allows manual or motorized actuation of illumination focusing mechanism 575 from outside the housing after the housing is sealed.

### Illumination Focusing Mechanism

According to some embodiments of the disclosure, illumination assembly 550 includes multiple lighting elements positioned around or in the vicinity of the image sensor. According to further embodiments of the disclosure, each lighting element may have its own focusing mechanism. Each illumination focusing mechanism may function independently or in coordination with other focusing mechanisms. In some mechanical focusing mechanisms, each illumination focusing mechanism may work with different transmission ratios if coupled or be controlled independently.

The illumination focusing mechanism is optionally linked to the image sensor's focus system. For instance, gears may connect the lighting element optics to the lens focusing mechanism so that both are adjusted together. Alternatively, the illumination focusing mechanism may remain independent and be controlled separately.

According to some embodiments of the disclosure, the focus distance may be set directly by the user and/or adjusted by mechanical actuators and/or controlled by software.

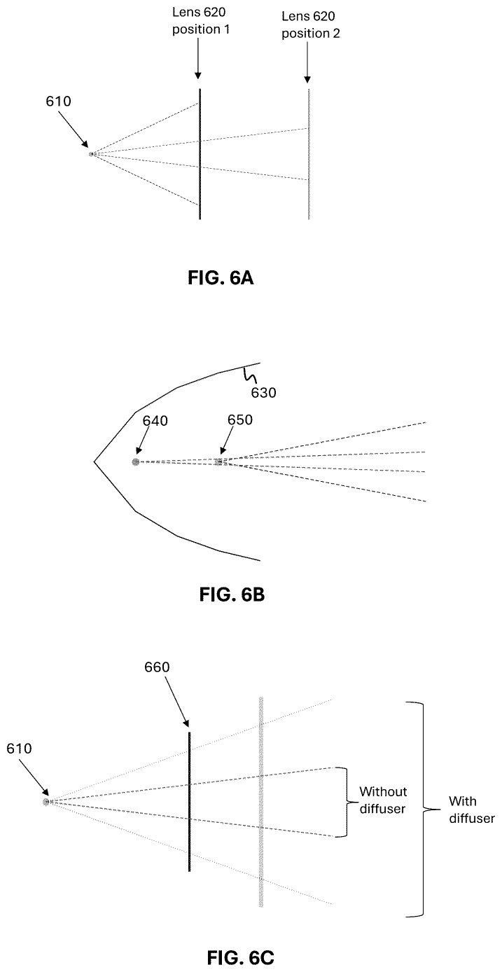

Reference is now made to FIGS. 6A-6C, which are simplified illustrations of illumination focus adjustment techniques, according to respective exemplary embodiments of the disclosure.

FIG. 6A illustrates a first example, in which a lens element 620 is moved between the lighting element 610 and the region of interest. By translating the lens 620 forward or backward along the optical axis, the divergence of the beam can be adjusted, producing a wider illumination for close targets or a narrower, focused beam for distant targets.

FIG. 6B illustrates a second example, in which the position of a lighting element is shifted relative to a reflector 630. When the lighting element is positioned at the focal point 640 of a parabolic reflector, the beam becomes collimated and narrow; when the lighting element is moved to 650 away from the focal point, the beam becomes wider and less uniform.

FIG. 6C illustrates a third example, in which a diffuser 660 may be inserted or removed between the lighting element 610 and the region of interest. By moving diffuser 660 (a translucent optical element) into or out of the beam path, the light may be rapidly changed from a sharp, concentrated beam to a soft, dispersed illumination.

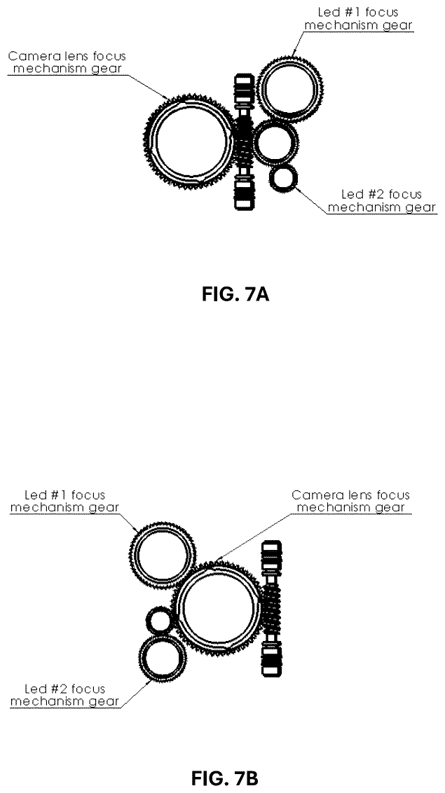

Reference is now made to FIGS. 7A-7B, which are simplified illustrations of coupled illumination focus adjustment mechanisms, according to respective exemplary embodiments according to the disclosure. In FIGS. 7A-7B multiple illumination focusing mechanisms are mechanically coupled to the lens focusing mechanism. In both Figures, a camera lens focus gear serves as the main element that distributes motion to the illumination focusing gears.

In FIG. 7A, the camera lens focus gear is driven by a worm screw, which provides precise motion control and a self-locking effect. From this gear, motion is transmitted through an intermediate gear train to two separate gears assigned to LED #1 and LED #2. Each illumination focusing mechanism may use a different gear ratio, allowing its focusing element to move according to a unique displacement profile relative to the camera's lens adjustment.

In FIG. 7B, the arrangement is modified: here the camera lens focus gear itself is the driver, without the worm screw as the primary actuator. The LED #1 and LED #2 focus gears are engaged directly with the lens focus gear, and their transmission ratios are determined by gear size and placement.

### Lighting Elements

Any suitable type of illumination may be used according to embodiments of the disclosure, such as a light emitting diode (LED), light bulb, laser, electroluminescent wire, and light transmitted via fiber optic wires or cables (e.g. from a LED coupled to the fiber optic cable).

According to some embodiments of the disclosure, illumination assembly 550 comprises multiple independently adjustable lighting elements. In some further embodiments, at least one of the lighting elements may be adjusted separately from lens assembly 525.

According to some embodiments of the disclosure, illumination assembly 550 comprises multiple lighting elements, where at least two of the lighting elements have different wavelength ranges.

### Processor Control

According to some embodiments of the disclosure, the lens focusing mechanism and the illumination focusing mechanism are controlled in coordination by processor circuitry (such as processing circuitry 114 of FIG. 1). The processing circuitry transmits instructions to one or more actuators or drivers, causing them to operate lens focusing mechanism 530 and illumination focusing mechanism 570.

According to some embodiments of the disclosure, the processing circuitry receives at least one specified focal property for image sensor 520 (such as focal distance). The processing circuitry determines the illumination parameters that create suitable lighting conditions when the image sensor operates with the specified focal properties. The processing circuitry then controls the lens focusing mechanism to provide the specified focal properties and controls the illumination focusing mechanism to provide the determined illumination parameters.

Processor control may operate in open loop, using predetermined motion, or in closed loop, using feedback for accuracy. For example, one or more images may be captured after lens focusing mechanism 530 and illumination focusing mechanism 570 are set. The images may be analyzed by the processor or by another processor, and subject to the analysis results, further changes may be made to lens focusing mechanism 530 and/or illumination focusing mechanism 570 to improve the captured images.

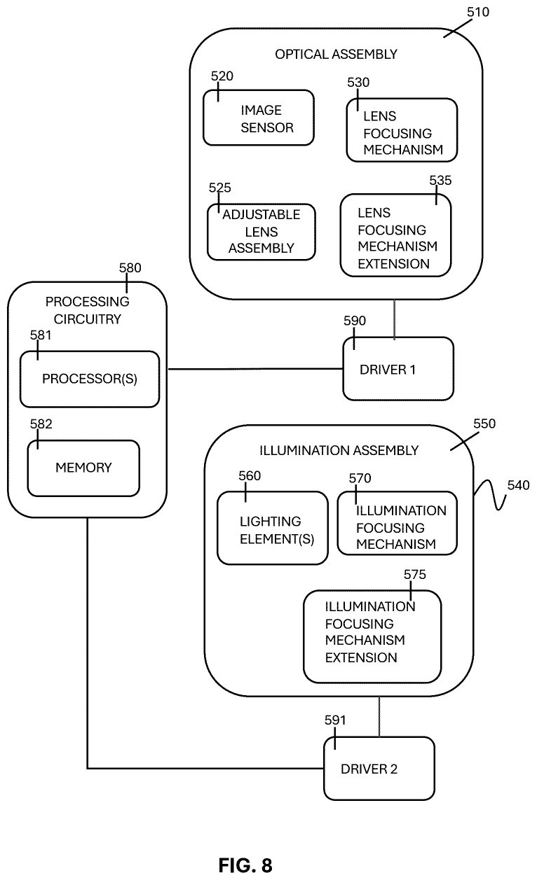

Reference is now made to FIG. 8, which is a simplified block diagram of an imaging system with processor control, according to an exemplary embodiment according to the disclosure. In FIG. 8, lens focusing mechanism 530 and illumination focusing mechanism 550 are controlled by processing circuitry 580. Processing circuitry 580 includes one or more processors 581, and memory 582 for storing instructions and/or data which cause the processors 581 to control the lens focusing mechanism 530 and illumination focusing mechanism 550 in coordination, according to any of the embodiments described herein. Processing circuitry 580 controls drivers 590 and 591 which mechanically adjust lens focusing mechanism 530 and illumination focusing mechanism 550 respectively.

### Housing

According to some embodiments of the disclosure, illumination assembly 550 is enclosed within housing 540, as shown in FIG. 5A. According to some alternate embodiments illustrated in FIG. 5B, optical assembly 510 and illumination assembly 550 are both enclosed within a single housing 545. In further alternate embodiments, optical assembly 510 is enclosed within a separate housing, so that optical assembly 510 and illumination assembly 550 are both protected from outside conditions but do not form a single physical unit.

Similarly to some of the above described embodiments, housing 540/545 is optionally designed to maintain the sustainability of the system in harsh conditions. Optionally, housing 540/545 is made from a material constructed to withstand extreme temperatures and corrosive substances, such as aluminium. Optionally, the housing is coated by a coating that is anodic to the housing material to enhance its resistance to corrosion for example.

In some embodiments, the thickness of the housing is also constructed to adapt to harsh conditions, for example the housing material may have a thickness of 2 mm or less, such as 1 mm or even 0.7, 0.6 or 0.5 mm for certain environments.

Housing 540/545 may further enclose additional components (not shown), including one or more power sources, processing circuitry, interfaces, and memory for operating and controlling the imaging system 500.

### Method of Imaging

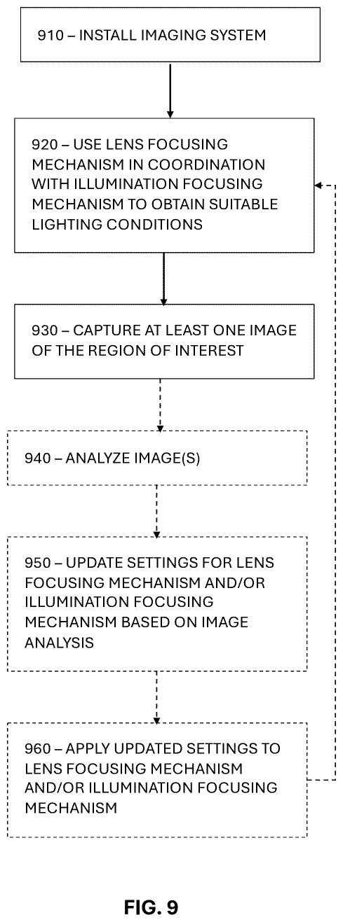

Reference is now made to FIG. 9, which is a simplified flowchart of a method for imaging a mechanical component, according to some embodiments of the disclosure.

In 910 an imaging system is installed. The imaging system may be in accordance with any of the embodiments described herein which includes coordinated adjustment of focal properties and illumination parameters.

The optical assembly and illumination assembly may be provided and installed as a single unit, for example when they are enclosed in the same housing. Alternately, the optical assembly and illumination assembly may be installed separately, either side by side or in separate locations.

Optionally, the illumination assembly includes multiple sub-assemblies, each having one or more lighting elements, and the sub-assemblies are installed at different locations.

The optical assembly is installed so that the image sensor is able to capture images of the region of interest.

The illumination assembly is installed so each of the lighting elements is capable of illuminating the region of interest.

In 920 the lens assembly and illumination assembly are adjusted in a coordinated manner, so as to obtain lighting conditions suitable for image capture of the area of interest by the image sensor. The lens assembly is adjusted using the lens focusing mechanism to obtain specified focal properties and the illumination assembly is adjusted using the illumination focusing mechanism.

In 930 at least one image of the region of interest is captured by the image sensor.

According to optional embodiments of the disclosure, in 940-960 the lens focusing mechanism and/or the illumination focusing mechanism are controlled by closed-loop feedback, based on image analysis of image(s) captured by the image sensor.

In 940, the captured image(s) are analyzed. If the illumination conditions are not suitable for the image sensor to capture high quality images of the region of interest, in 950 at least one setting of the lens focusing mechanism and/or the illumination focusing mechanism is updated. In 960, the updated setting(s) are applied to the lens focusing mechanism and/or the illumination focusing mechanism. If the lighting conditions are suitable, the current settings may be left without change if desired.

According to some embodiments of the disclosure the camera focus and the illumination assembly focus are adjusted together, based on the same image analysis results.

According to some alternate or additional embodiments of the disclosure, the camera focus and the illumination assembly focus are adjusted in separate steps. For example, first the lens focusing mechanism settings are adjusted (e.g., in response to changes in the region of interest and/or the results of a previous image analysis step). Then the image(s) are analyzed and the illumination focusing mechanism settings are adjusted if needed.

In some cases it may not be necessary to adjust both the lens assembly and illumination assembly to obtain suitable lighting conditions for the image sensor. For example, if the lens assembly is adjusted only slightly the current lighting conditions may still be suitable. Alternately or additionally, if image analysis determines that the image quality is not sufficient, the illumination assembly settings may be changed to provide improved lighting conditions without changing the lens assembly settings.

According to some embodiments of the disclosure, the illumination assembly and/or optical assembly are enclosed by a housing and controllable from outside the housing after the housing is sealed.

According to some embodiments of the disclosure, adjusting the at least one lighting element includes varying at least one parameter selected from the group consisting of: a divergence of the light beam emitted by the lighting element, a focus of the light beam emitted by the lighting element, a collimation of the light beam emitted by the lighting element, and a dispersion of the light beam emitted by the lighting element.

According to some embodiments of the disclosure, illuminating the area of interest includes controlling multiple independently adjustable lighting elements, and wherein the illumination parameter includes selecting at least one of the plurality of lighting elements for operation. According to some embodiments of the disclosure, the focal properties of the image sensor include at least one of: focal distance, focal length, depth of field and field of view.

1. An imaging system comprising:
an optical assembly comprising:
an image sensor, configured for capturing images of a region of interest;
an adjustable lens assembly, comprising at least one optical lens; and
a lens focusing mechanism coupled to said adjustable lens assembly, configured for adjusting said lens to obtain at least one specified focal property for the image sensor; and
an illumination assembly enclosed by a housing and associated with the optical assembly, comprising:
at least one lighting element, configured to illuminate the region of interest being imaged by the image sensor; and
an illumination focusing mechanism associated with said lens focusing mechanism, configured for adjusting an illumination parameter of said at least one lighting element in coordination with said lens focusing mechanism so as to obtain lighting conditions suitable for said image sensor,
wherein said illumination focusing mechanism is controllable from outside the housing after the housing is sealed.

2. An imaging system according to claim 1, wherein said housing further encloses said optical assembly, and the lens focusing mechanism is controllable from outside the housing after the housing is sealed.

3. An imaging system according to claim 1, wherein said illumination parameters include at least one parameter selected from the group consisting of: a divergence of a light beam emitted by the lighting element, a focus of the light beam emitted by the lighting element, a collimation of the light beam emitted by the lighting element and a dispersion of the light beam emitted by the lighting element.

4. An imaging system according to claim 1, wherein said illumination assembly comprises a plurality of independently adjustable lighting elements.

5. An imaging system according to claim 4, wherein said adjusting an illumination parameter comprises selecting at least one of plurality of lighting elements for operation.

6. An imaging system according to claim 4, wherein at least two of the lighting elements have different wavelengths.

7. An imaging system according to claim 1, wherein the lens focusing mechanism and the illumination focusing mechanism are mechanically coupled, such that adjusting the lens focusing mechanism mechanically adjusts the illumination focusing mechanism.

8. An imaging system according to claim 1, wherein the lens focusing mechanism and the illumination focusing mechanism are controlled in coordination by a processing circuitry transmitting instructions to one or more drivers.

9. An imaging system according to claim 1, wherein the lens focusing mechanism and the illumination focusing mechanism are adjusted from outside said housing by respective actuators.

10. An imaging system according to claim 1, wherein the illumination focusing mechanism comprises a lens that is movable forwards and backwards along the optical axis of a light beam emitted by the at least one lighting element.

11. An imaging system according to claim 1, wherein the illumination focusing mechanism comprises a reflector, and the at least one lighting element is movable closer and farther from a focal point of the reflector.

12. An imaging system according to claim 1, wherein the illumination focusing mechanism comprises a reflector that is insertable and removable from a light beam emitted by the at least one lighting element.

13. An imaging system according to claim 1, wherein the focal properties of the image sensor include at least one of a group consisting of: focal distance, focal length, depth of field and field of view.

14. An imaging system according to claim 1, further comprising a processing circuitry configured for:
receiving the at least one specified focal property for the image sensor;
determining the illumination parameters that create said suitable lighting conditions based on the specified focal properties; and
controlling the lens focusing mechanism to provide the specified focal properties and controlling the illumination focusing mechanism to provide the determined illumination parameters.

15. An imaging system according to claim 1, wherein said illumination assembly comprises a plurality of independently adjustable lighting elements and at least one of the lighting elements is adjustable separately from the image sensor lens.

16. A method for imaging a mechanical component comprising:
installing an imaging system comprising:
an optical assembly comprising:
an image sensor comprising an adjustable lens assembly, and configured for capturing images of a region of interest; and
a lens focusing mechanism coupled to the adjustable lens, configured for adjusting the lens assembly to obtain at least one specified focal property for the image sensor; and
an illumination assembly, comprising:
at least one lighting element, configured to illuminate the region of interest being imaged by the image sensor; and
an illumination focusing mechanism associated with the lens focusing element, configured for adjusting an illumination parameter of the at least one lighting element;
adjusting the lens assembly using the lens focusing mechanism to obtain the at least one specified focal property in coordination with adjusting the at least one lighting element using the illumination focusing mechanism, so as to obtain lighting conditions suitable for image capture of the region of interest by the image sensor; and
capturing at least one image of the region of interest by the image sensor.

17. The method of claim 16, wherein the illumination assembly is enclosed by a housing and is controllable from outside the housing after the housing is sealed.

18. The method of claim 16, wherein adjusting the at least one lighting element comprises varying at least one parameter selected from the group consisting of: a divergence of the light beam emitted by the lighting element, a focus of the light beam emitted by the lighting element, a collimation of the light beam emitted by the lighting element, and a dispersion of the light beam emitted by the lighting element.

19. The method of claim 16, wherein illuminating the region of interest comprises controlling a plurality of independently adjustable lighting elements, and wherein adjusting the illumination parameter comprises selecting at least one of the plurality of lighting elements for operation.

20. The method of claim 16, wherein the focal properties of the image sensor include at least one of a group consisting of: focal distance, focal length, depth of field and field of view.

21. The method of claim 16, further comprising:
analyzing the at least one captured image to determine if current lighting conditions are suitable for image capture of the region of interest by the image sensor;
if current lighting conditions are unsuitable, updating at least one setting of the lens focusing mechanism and/or the illumination focusing mechanism; and
applying the at least one updated setting to the lens focusing mechanism and/or the illumination focusing mechanism.
